(19) United States
(12) Patent Application Publication
(10) Pub. No.: US 2023/0077492 A1
(43) Pub. Date: Mar. 16, 2023

(54) HYBRID ELECTRIC VEHICLE AND ENGINE CONTROL METHOD THEREFOR

(71) Applicants: Hyundai Motor Company, Seoul (KR); Kia Corporation, Seoul (KR)

(72) Inventors: Won Bin Lee, Suwon (KR); Sang Kook Woo, Seongnam (KR); Soo Bang Lee, Suwon (KR); Se Geun Kim, Yongin (KR)

(21) Appl. No.: 17/944,792

(22) Filed: Sep. 14, 2022

(30) Foreign Application Priority Data
Sep. 16, 2021 (KR) 10-2021-0124065

(51) Int. Cl. B60W 20/10; B60W 10/08

(52) U.S. Cl. CPC B60W 20/10; B60W 10/08; B60W 2540/10; B60W 2710/083; B60W 2510/081; B60W 2510/087; B60W 2510/244

(57) ABSTRACT

Disclosed are a hybrid electric vehicle and an engine control method therefor that are capable of reducing entry of an engine into a full-load drive mode. The method includes determining whether the extent of depression of an accelerator pedal (APS) may be equal to or greater than a reference value set as a condition for entry of an engine into a full-load drive mode, determining a part-load torque corresponding to the maximum torque in a part-load drive mode of the engine and a motor torque corresponding to the maximum torque of a motor when the extent of depression of the accelerator pedal may be equal to or greater than the reference value, comparing the sum of the part-load torque and the motor torque with a driver demand torque, and controlling the engine in the full-load drive mode or the part-load drive mode depending on a result of the comparing.

### CROSS-REFERENCE TO RELATED APPLICATIONS

This application claims under 35 U.S.C. § 119(a) the benefit of Korean Patent Application No. 10-2021-0124065, filed on Sep. 16, 2021, which is hereby incorporated by reference as if fully set forth herein.

### TECHNICAL FIELD

The present disclosure relates to a hybrid electric vehicle and an engine control method that may be capable of reducing entry of an engine into a full-load drive mode.

### BACKGROUND

Recently, with increased concern about the environment, environmentally friendly vehicles, which may be provided with electric motors as a power source, have been actively developed. Environmentally friendly vehicles may also be called motorized vehicles, and hybrid electric vehicles (HEVs) have been developed as a representative example of environmentally friendly vehicles.

A hybrid electric vehicle (HEV) may be a vehicle that selectively drives an electric motor or an engine depending on the driving environment in order to reduce emissions and improve fuel efficiency.

In such a hybrid electric vehicle, an engine may be controlled in a part-load drive mode or a full-load drive mode depending on the driving environment. Here, the full-load drive mode may be a drive mode that may be executed in order to output maximum torque, and the part-load drive mode may be a drive mode that may be executed taking into account the efficiency of purification of emissions, such as hydrocarbons (HC), carbon monoxide (CO), and nitrogen oxides (NOx). For example, in the part-load drive mode, the engine may be driven so that a lambda value, which may be a value obtained by dividing the air-fuel ratio of an air-fuel mixture introduced into the engine by a theoretical air-fuel ratio, reaches 1. Because the proportion of fuel in the full-load drive mode may be greater than in the part-load drive mode, the lambda value may be lower than 1, and the efficiency of purification of emissions may be reduced.

In general, the maximum torque output from the engine in the part-load drive mode may be lower than in the full-load drive mode. Therefore, in the normal drive state of the hybrid electric vehicle, when engine startup may be required, the engine may be controlled in the part-load drive mode, and when the maximum torque may be required, the engine may be controlled in the full-load drive mode.

FIG. 1 shows an example of logic for determining whether to enter a full-load drive mode in a general hybrid electric vehicle.

Referring to FIG. 1, in a general hybrid electric vehicle, when an engine startup (on) may be required, if the extent of depression of the accelerator pedal (APS) satisfies a predetermined APS condition, the engine enters a full-load drive mode. Here, the predetermined APS condition may be variously set depending on the characteristics of the vehicle. In general, the predetermined APS condition may be set to about 90% of a complete depression of the accelerator pedal.

When the engine may be controlled in the full-load drive mode, high torque may be obtained, as described above. However, fuel efficiency may be deteriorated, and emissions may greatly increase.

### SUMMARY DISCLOSURE

Accordingly, the present disclosure may be directed to a hybrid electric vehicle and an engine control method that substantially obviates one or more problems due to limitations and disadvantages of the related art.

An object of the present disclosure may be to provide a hybrid electric vehicle and an engine control method that may be capable of reducing entry of an engine into a full-load drive mode.

However, the objects to be accomplished by the disclosure are not limited to the above-mentioned objects, and other objects not mentioned herein will be clearly understood by those skilled in the art from the following description.

In order to accomplish the above and other objects, a method of controlling an engine of a hybrid electric vehicle according to an embodiment of the present disclosure includes determining whether the extent of depression of an accelerator pedal (APS) may be equal to or greater than a reference value set as a condition for entry of the engine into a full-load drive mode, determining a part-load torque corresponding to a first maximum torque in a part-load drive mode of the engine and a motor torque corresponding to a second maximum torque of a motor when the extent of depression of the accelerator pedal may be equal to or greater than the reference value, comparing the sum of the part-load torque and the motor torque with a driver demand torque, and controlling the engine in the full-load drive mode or the part-load drive mode depending on a result of the comparing.

For example, the controlling may include controlling the engine in the part-load drive mode when the sum may be equal to or greater than the driver demand torque.

For example, the method may further include controlling the engine to the part-load torque and controlling the motor to a torque obtained by subtracting the part-load torque from the driver demand torque.

For example, the controlling may include controlling the engine in the full-load drive mode when the sum may be less than the driver demand torque.

For example, the method may further include controlling the engine to the maximum torque in the full-load drive mode and controlling the motor to a torque obtained by subtracting the maximum torque in the full-load drive mode from the driver demand torque.

For example, the determining a part-load torque may be performed taking into account an external environment condition and the current speed (RPM) of the engine.

For example, the external environment condition may include atmospheric pressure.

For example, the determining a motor torque may be performed taking into account at least one of the current speed, such as the revolutions per minute(RPM), of the motor, the temperature of the motor, the state of charge (SOC) of a battery, or the temperature of a power electric (PE) component.

In addition, a method of controlling an engine of a hybrid electric vehicle according to an embodiment of the present disclosure includes determining whether the extent of depression of an accelerator pedal (APS) may be equal to or greater than a reference value set as a condition for entry of the engine into a full-load drive mode, determining a part-load torque corresponding to a first maximum torque in a part-load drive mode of the engine and a motor torque corresponding to a second maximum torque of a motor when the extent of depression of the accelerator pedal may be equal to or greater than the reference value, comparing the sum of the part-load torque and the motor torque with an allowable transmission torque, and controlling the engine in the full-load drive mode or the part-load drive mode depending on a result of the comparing.

In addition, a hybrid electric vehicle according to an embodiment of the present disclosure includes an engine, a motor, and a first controller configured to determine whether the extent of depression of an accelerator pedal (APS) may be equal to or greater than a reference value set as a condition for entry of the engine into a full-load drive mode, to determine a part-load torque corresponding to a first maximum torque in a part-load drive mode of the engine and a motor torque corresponding to a second maximum torque of the motor when the extent of depression of the accelerator pedal may be equal to or greater than the reference value, and to control the engine in the full-load drive mode or the part-load drive mode depending on a result of comparing the sum of the part-load torque and the motor torque with a driver demand torque.

For example, the first controller may control the engine in the part-load drive mode when the sum may be equal to or greater than the driver demand torque.

For example, the hybrid electric vehicle may further include a second controller configured to control the engine and a third controller configured to control the motor. The first controller may be configured to transmit a torque command corresponding to the part-load torque to the second controller, and may transmit a torque command corresponding to a torque, obtained by subtracting the part-load torque from the driver demand torque, to the third controller.

For example, the first controller may be configured to control the engine in the full-load drive mode when the sum may be less than the driver demand torque.

For example, the hybrid electric vehicle may further include a second controller configured to control the engine and a third controller configured to control the motor. The first controller may be configured to transmit a torque command corresponding to a third maximum torque in the full-load drive mode to the second controller, and may transmit a torque command corresponding to a torque, obtained by subtracting the third maximum torque in the full-load drive mode from the driver demand torque, to the third controller.

For example, the first controller may be configured to determine the part-load torque based on an external environment condition and the current speed (RPM) of the engine.

For example, the external environment condition may include atmospheric pressure.

For example, the first controller may be configured to determine the motor torque based on at least one of the current speed (RPM) of the motor, the temperature of the motor, the state of charge (SOC) of a battery, or the temperature of a power electric (PE) component.

In addition, a hybrid electric vehicle according to an embodiment of the present disclosure includes an engine, a motor, a transmission, and a first controller configured to determine whether the extent of depression of an accelerator pedal (APS) may be equal to or greater than a reference value set as a condition for entry of the engine into a full-load drive mode, to determine a part-load torque corresponding to the maximum torque in a part-load drive mode of the engine and a motor torque corresponding to the maximum torque of the motor when the extent of depression of the accelerator pedal may be equal to or greater than the reference value, and to control the engine in the full-load drive mode or the part-load drive mode depending on a result of comparing the sum of the part-load torque and the motor torque with an allowable torque at the input end of the transmission.

### BRIEF DESCRIPTION OF THE DRAWINGS

The accompanying drawings, which may be included to provide a further understanding of the disclosure and may be incorporated in and constitute a part of this application, illustrate embodiment(s) of the disclosure and together with the description serve to explain the principle of the disclosure. In the drawings:

FIG. 1 shows an example of logic for determining whether to enter a full-load drive mode in a general hybrid electric vehicle;

FIG. 2 shows an example of the structure of a powertrain of a hybrid electric vehicle to which embodiments of the present disclosure may be applicable;

FIG. 3 shows an example of the structure of a control system of a hybrid electric vehicle according to an embodiment of the present disclosure;

FIGS. 4A to 4C are diagrams for explaining the maximum torque of a hybrid powertrain according to an embodiment;

FIG. 5 is a flowchart showing an example of an engine control process according to an embodiment of the present disclosure; and

FIG. 6 shows an example of logic for determining whether to enter a full-load drive mode in the hybrid electric vehicle according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the embodiments disclosed in the present specification will be described in detail with reference to the accompanying drawings, and the same or similar elements may be denoted by the same reference numerals even though they may be depicted in different drawings, and redundant descriptions thereof will be omitted. In the following description, with respect to constituent elements used in the following description, the suffixes “module” and “unit” may be used only in consideration of facilitation of description, and do not have mutually distinguished meanings or functions. In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings may be provided only for a better understanding of the embodiments disclosed in the present specification and may not be intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms may be used to distinguish one component from another component.

It will be understood that when a component may be referred to as being “connected to” or “coupled to” another component, it may be directly connected to or coupled to another component, or intervening components may be present. On the other hand, when a component may be referred to as being “directly connected to” or “directly coupled to” another component, there may be no intervening components present.

As used herein, the singular form may be intended to include the plural forms as well, unless the context clearly indicates otherwise.

It will be further understood that the terms “comprises”, “comprising”, “includes”, and/or “including”, when used herein, specify the presence of stated features, integers, steps, operations, elements, components, or combinations thereof, but do not preclude the presence or addition of one or more other features, integers, steps, operations, elements, components, or combinations thereof.

The term “unit” or “control unit” forming part of the name of the motor control unit (MCU) or the hybrid control unit (HCU) may be merely a term that may be widely used in naming a controller for controlling a specific function of a vehicle, and should not be construed as meaning a generic function unit. For example, in order to control the function peculiar thereto, each control unit may include a communication device, which communicates with other control units or sensors, a memory, which stores therein an operating system, logic commands, and input/output information, and one or more processors, which perform determinations, calculations, and decisions necessary for control of the function peculiar thereto.

Prior to describing a hybrid electric vehicle and an engine control method therefor according to embodiments of the present disclosure, the structure and the control system of a hybrid electric vehicle to which the embodiments may be applicable will be described first.

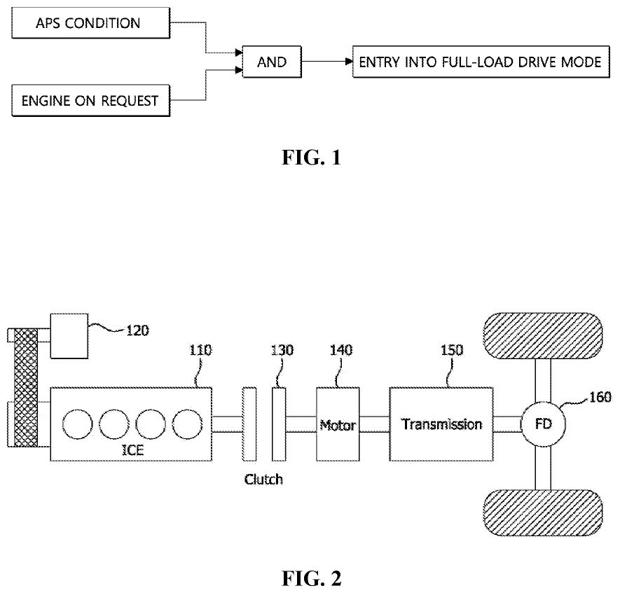

FIG. 2 shows an example of the structure of a powertrain of a hybrid electric vehicle to which the embodiments of the present disclosure may be applicable.

FIG. 2 illustrates the structure of the powertrain of a hybrid electric vehicle equipped with a parallel-type hybrid system, in which an electric motor (or a drive motor) 140 and an engine clutch 130 may be disposed between an internal combustion engine (ICE) 110 and a transmission 150.

In such a vehicle, when a driver steps on an accelerator pedal (i.e. accelerator pedal sensor on) after commencing movement of the vehicle, the motor 140 may be first driven using the power of a battery in the state in which the engine clutch 130 may be open, and then the power of the motor may be transmitted to the wheels via the transmission 150 and a final drive (FD) 160 in order to rotate the wheels (i.e. an EV mode). When greater driving force may be needed as the vehicle may be accelerated, an auxiliary motor (or a starter/generator motor) 120 may be operated so as to drive the engine 110.

When a difference in the rotational speed between the engine 110 and the motor 140 may be within a predetermined range, the engine clutch 130 may be locked, with the result that both the engine 110 and the motor 140 drive the vehicle (i.e. transition from the EV mode to an HEV mode). When a predetermined engine OFF condition may be satisfied, for example, when the vehicle may be decelerated, the engine clutch 130 may be opened, and the engine 110 may be stopped (i.e. transition from the HEV mode to the EV mode). In this case, the vehicle charges the battery 170 through the motor 140 using the driving force of the wheels. This may be referred to as recovery of braking energy or regenerative braking. The starter/generator motor 120 serves as a starter motor when the engine may be started, and also operates as a generator when the rotational energy of the engine may be collected after the engine may be started or when the engine may be turned off. Therefore, the starter/generator motor 120 may be referred to as a hybrid starter generator (HSG).

In general, the transmission 150 may be implemented as a multiple-range transmission or a multiple-disc clutch transmission, for example, a dual-clutch transmission (DCT).

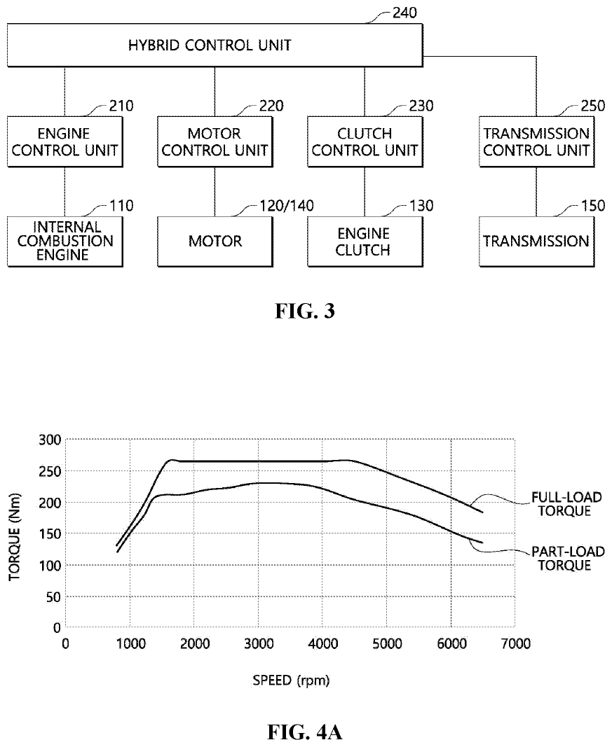

FIG. 3 is a block diagram showing an example of a control system of a hybrid electric vehicle to which the embodiments of the present disclosure may be applicable.

Referring to FIG. 3, in a hybrid electric vehicle to which the embodiments of the present disclosure may be applicable, the internal combustion engine 110 may be controlled by an engine control unit 210. The torque of the starter/generator motor 120 and the drive motor 140 may be controlled by a motor control unit (MCU) 220. The engine clutch 130 may be controlled by a clutch control unit 230. Here, the engine control unit 210 may be referred to as an engine management system (EMS). In addition, the transmission 150 may be controlled by a transmission control unit 250.

Each of the control units may be connected to a hybrid control unit (HCU) 240, which may be a higher-level control unit that controls the overall process of mode switching, and may provide information necessary for engine clutch control at the time of switching a drive mode or shifting gears and/or information necessary for engine stop control to the hybrid control unit 240, or may perform an operation in response to a control signal under the control of the hybrid control unit 240.

For example, the hybrid control unit 240 may be configured to determines whether to perform mode switching between the EV mode and the HEV mode or between the CD mode and the CS mode depending on the driving state of the vehicle. To this end, the hybrid control unit may be configured to determine the time at which to disengage (open) the engine clutch 130, and performs hydraulic pressure control when the engine clutch may be disengaged. In addition, the hybrid control unit 240 may be configured to determine the state of the engine clutch 130 (lock-up, slip, open, etc.), and may control the time at which to stop injecting fuel into the engine 110. In addition, the hybrid control unit may be configured to transmit a torque command for controlling the torque of the starter/generator motor 120 to the motor control unit 220 in order to control stopping of the engine, thereby controlling recovery of rotational energy from the engine. In addition, the hybrid control unit 240 may be configured to control the lower-level control units in order to determine mode-switching conditions and perform mode switching at the time of performing drive-mode-switching control. Particularly, in relation to the embodiments of the present disclosure, the hybrid control unit 240 may be configured to determine whether to control the engine in the part-load drive mode or in the full-load drive mode.

Of course, it will be apparent to those skilled in the art that the connection relationships between the control units and the functions/division of the control units described above may be merely illustrative and may not be limited by the names thereof. For example, the hybrid control unit 240 may be implemented such that the function thereof may be provided by any one of the control units other than the hybrid control unit 240 or such that the function thereof may be distributed and provided by two or more of the other control units.

It will be apparent to those skilled in the art that the configuration described above with reference to FIGS. 2 and 3 is merely an exemplary configuration of the hybrid electric vehicle, and the structure of the hybrid electric vehicle to which the embodiments are applicable is not limited thereto.

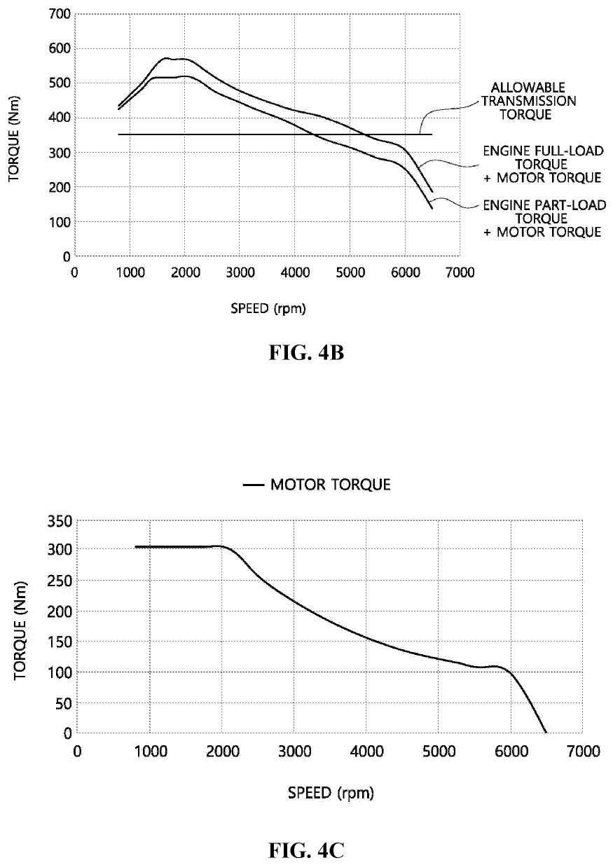

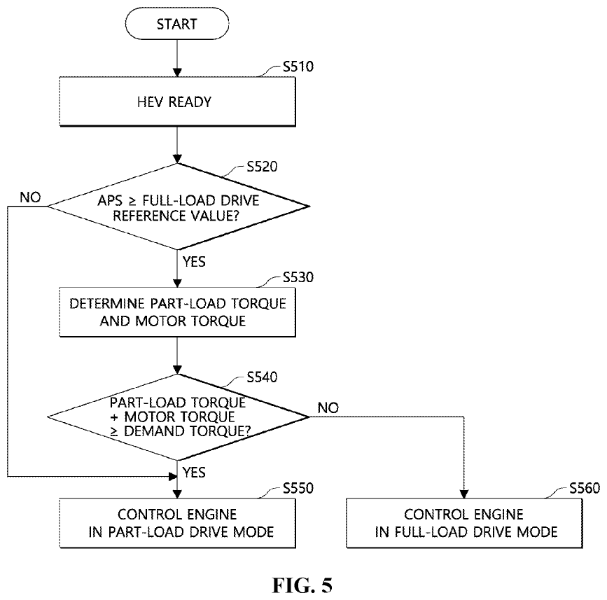

FIGS. 4A to 4C are diagrams for explaining the maximum torque of a hybrid powertrain according to an exemplary embodiment. In each of the graphs shown in FIGS. 4A to 4C, the horizontal axis represents the rotational speed (the number of revolutions per minute (RPM)) of the corresponding drive source, and the vertical axis represents torque.

First, referring to FIG. 4A, it may be seen that the full-load torque may be higher than the part-load torque in the entire range of the available rotational speed of the engine. The maximum torque of the motor for each speed may be as shown in FIG. 4B.

As described above, in the hybrid electric vehicle, when the engine clutch 130 may be engaged, the motor 140 and the engine 110 rotate together, so the torque of the engine 110 and the torque of the motor 140 may be summed, and the speed (RPM) of the engine 110 and the speed (RPM) of the motor 140 become equal to each other.

Accordingly, when the engine having the performance shown in FIG. 4A and the motor having the performance shown in FIG. 4B rotate together through engagement of the engine clutch 130, the maximum torque for each speed may be as shown in FIG. 4C.

However, since the maximum allowable torque at the input end of the transmission 150 (hereinafter referred to as “allowable transmission torque”) may be set, the hybrid control unit 240 controls the torque of the powertrain in response to depression of the accelerator pedal APS by the driver such that the total torque, obtained by summing the torque of the engine 110 and the torque of the motor 140, does not exceed the allowable transmission torque. Referring to FIG. 4C, when the extent of depression of the accelerator pedal APS by the user may be the maximum, it may be possible to satisfy driver demand torque below about 4500 RPM even though the engine may be controlled in the part-load drive mode. That is, although there may be some variation depending on the performance of the powertrain of respective vehicle models, it may not be necessary to enter the full-load drive mode in the RPM region in which the value obtained by summing the maximum torque of the engine and the maximum torque of the motor in the part-load drive mode may be greater than the allowable transmission torque even though a predetermined APS value set as a full-load drive mode entry condition of the engine may be satisfied.

Accordingly, in the hybrid electric vehicle according to an embodiment of the present disclosure, even though the full-load drive mode entry condition related to depression of the accelerator pedal may be satisfied in the situation in which there may be a request for engine startup, the engine may be controlled in the part-load drive mode if the driver demand torque may be satisfied through the part-load drive mode.

FIG. 5 is a flowchart showing an example of an engine control process according to an embodiment of the present disclosure.

Referring to FIG. 5, in the state in which the hybrid electric vehicle may be drivable (e.g. an HEV ready state) (S510), the hybrid control unit 240 may determine whether the extent of depression of the accelerator pedal APS may be equal to or greater than a predetermined full-load drive reference value (S520). Of course, this step may be configured to further determine whether there may be an engine on request as a condition for determining whether to enter the full-load drive mode. In general, however, the APS value corresponding to entry into the full-load drive mode may be larger than the APS value that may be interpreted as demand torque, based on which switching to the HEV mode may be performed. Therefore, the engine on request may be considered to be naturally satisfied.

When it is determined that the APS value is equal to or greater than the full-load drive reference value (Yes in S520), the hybrid control unit 240 may determine the part-load torque of the engine 110 and the maximum torque of the motor 140 (S530).

Here, the part-load torque is the maximum torque that the engine 110 may output in the current situation through the part-load drive mode. For example, the maximum torque of the engine may be affected by the external environment, such as atmospheric pressure (the lower the atmospheric pressure, the lower the maximum torque), and the current RPM, as shown in FIG. 4A.

In addition, the maximum torque of the motor 140 may be affected by the current RPM of the motor, as shown in FIG. 4B, and may also be affected by the state of charge (SOC) of the battery, which supplies power to the motor 140, the temperature of a power electric (PE) component, such as an inverter, and the temperature of the motor 140. Accordingly, the hybrid control unit 140 may determine the maximum torque of the motor 140 based on at least one of the temperature of the motor 140, the current RPM of the motor, the SOC of the battery, or the temperature of the PE component.

After the part-load torque and the torque of the motor may be determined, the hybrid control unit 240 may determine whether the sum of the part-load torque and the torque of the motor may be equal to or greater than the driver demand torque (S540). Here, the driver demand torque may be determined based on the extent of depression of the accelerator pedal APS and the extent of depression of the brake pedal (BPS).

When it may be determined that the sum of the part-load torque and the torque of the motor may be equal to or greater than the driver demand torque (Yes in S540), the hybrid control unit 240 may determine to control the engine 110 in the part-load drive mode because the demand torque may be satisfied without entry into the full-load drive mode (S550). In this case, the hybrid control unit 240 may transmit a torque command corresponding to the part-load torque determined in step S530 to the engine control unit 210, and may transmit a torque command corresponding to the value obtained by subtracting the part-load torque from the demand torque to the motor control unit 220.

Meanwhile, when the sum of the part-load torque and the torque of the motor may be less than the driver demand torque (No in S540), the hybrid control unit 240 may determine to control the engine 110 in the full-load drive mode in order to satisfy the driver demand torque because the driver demand torque may not be satisfied in the part-load drive mode (S560). Accordingly, the hybrid control unit 240 may transmit a torque command corresponding to the maximum torque that may be output in the full-load drive mode at the current RPM to the engine control unit 210, and may transmit a torque command corresponding to the value obtained by subtracting the torque to be output by the engine from the driver demand torque to the motor control unit 220.

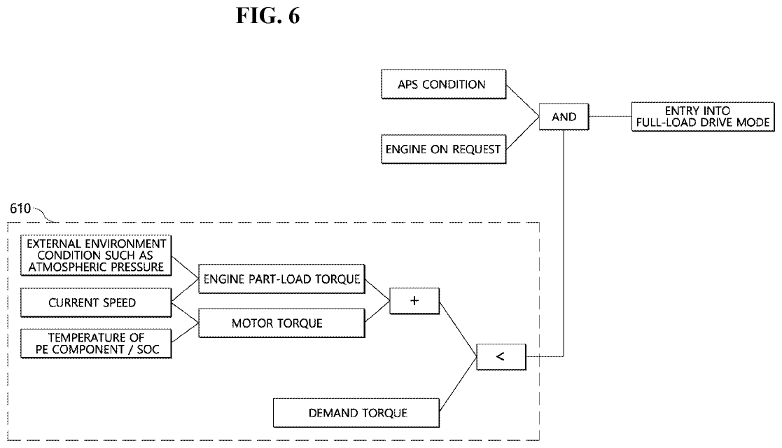

Hereinafter, entry of the engine into the full-load drive mode through the above-described engine control process will be described with reference to FIG. 6.

FIG. 6 is a diagram showing an example of logic for determining whether to enter the full-load drive mode in the hybrid electric vehicle (EV) according to an embodiment of the present disclosure.

Referring to FIG. 6, according to the embodiment, a determination 610 as to whether the sum of the part-load torque and the torque of the motor may be less than the demand torque may be performed, in addition to a determination on the APS condition and a determination on the engine on request, compared to the general full-load drive mode entry determination logic shown in FIG. 1.

As described above, according to the engine control method of the embodiment, even though the APS condition may be satisfied in the situation in which there may be an engine on request, entry into the full-load drive mode may be performed only when the sum of the part-load torque and the torque of the motor may be less than the demand torque. Therefore, if the driver demand torque may be satisfied through the part-load drive mode, it may not be necessary to enter the full-load drive mode. Accordingly, it may be possible to prevent deterioration in fuel efficiency and increase of emissions attributable to unnecessary entry into the full-load drive mode.

In the above-described embodiments, the situation in which the APS condition for entry into the full-load drive mode may be satisfied may be the situation in which the APS value may be about 90% or more of a full depression of the accelerator pedal, and the demand torque in this situation may be substantially identical to the transmission limit torque. Accordingly, in the above-described embodiment, the demand torque that may be compared with the sum of the part-load torque and the torque of the motor in step S540 of FIG. 5 may be substituted with the transmission limit torque.

Meanwhile, the present disclosure may be implemented as code that may be written on a computer-readable recording medium and thus read by a computer system. The computer-readable recording medium includes all kinds of recording devices in which data that may be read by a computer system may be stored. Examples of the computer-readable recording medium include a Hard Disk Drive (HDD), a Solid-State Disk (SSD), a Silicon Disk Drive (SDD), a Read-Only Memory (ROM), a Random Access Memory (RAM), a Compact Disk ROM (CD-ROM), a magnetic tape, a floppy disc, and an optical data storage.

As may be apparent from the above description, a hybrid electric vehicle according to various embodiments of the present disclosure may reduce unnecessary entry of an engine into a full-load drive mode. Accordingly, emissions may be reduced, and fuel efficiency may be improved.

However, the effects achievable through the present disclosure may not be limited to the above-mentioned effects, and other effects not mentioned herein will be clearly understood by those skilled in the art from the above description.

It will be apparent to those skilled in the art that various changes in form and details may be made without departing from the spirit and essential characteristics of the disclosure set forth herein. Accordingly, the above detailed description may not be intended to be construed to limit the disclosure in all embodiments and to be considered by way of example. The scope of the disclosure should be determined by reasonable interpretation of the appended claims and all equivalent modifications made without departing from the disclosure should be included in the following claims.

What is claimed is:

1. A method of controlling an engine of a hybrid electric vehicle, the method comprising:
determining whether an extent of depression of an accelerator pedal (APS) is equal to or greater than a reference value set as a condition for entry of the engine into a full-load drive mode;
determining a part-load torque corresponding to a first maximum torque in a part-load drive mode of the engine and a motor torque corresponding to a second maximum torque of a motor when the extent of depression of the accelerator pedal is equal to or greater than the reference value;
comparing a sum of the part-load torque and the motor torque with a driver demand torque; and
controlling the engine in the full-load drive mode or the part-load drive mode depending on a result of the comparing.

2. The method according to claim 1, wherein the controlling comprises:
controlling the engine in the part-load drive mode when the sum is equal to or greater than the driver demand torque.

3. The method according to claim 2, further comprising:
controlling the engine to the part-load torque; and
controlling the motor to a torque obtained by subtracting the part-load torque from the driver demand torque.

4. The method according to claim 1, wherein the controlling comprises:
controlling the engine in the full-load drive mode when the sum is less than the driver demand torque.

5. The method according to claim 4, further comprising:
controlling the engine to a third maximum torque in the full-load drive mode; and
controlling the motor to a torque obtained by subtracting the third maximum torque in the full-load drive mode from the driver demand torque.

6. The method according to claim 1, wherein the determining a part-load torque is performed by taking into account an external environment condition and a current speed of the engine.

7. The method according to claim 6, wherein the external environment condition comprises atmospheric pressure.

8. The method according to claim 1, wherein the determining the motor torque is performed taking into account at least one of a current speed of the motor, a temperature of the motor, a state of charge (SOC) of a battery, or a temperature of a power electric (PE) component.

9. A method of controlling an engine of a hybrid electric vehicle, the method comprising:
determining whether an extent of depression of an accelerator pedal (APS) is equal to or greater than a reference value set as a condition for entry of the engine into a full-load drive mode;
determining a part-load torque corresponding to a first maximum torque in a part-load drive mode of the engine and a motor torque corresponding to a second maximum torque of a motor when the extent of depression of the accelerator pedal is equal to or greater than the reference value;
comparing a sum of the part-load torque and the motor torque with an allowable transmission torque; and
controlling the engine in the full-load drive mode or the part-load drive mode depending on a result of the comparing.

10. A computer-readable recording medium containing a program configured to perform the method of controlling an engine of a hybrid electric vehicle according to claim 1.

11. A hybrid electric vehicle, comprising:
an engine;
a motor; and
a first controller configured to determine whether an extent of depression of an accelerator pedal (APS) is equal to or greater than a reference value set as a condition for entry of the engine into a full-load drive mode, to determine a part-load torque corresponding to a first maximum torque in a part-load drive mode of the engine and a motor torque corresponding to a second maximum torque of the motor when the extent of depression of the accelerator pedal is equal to or greater than the reference value, and to control the engine in the full-load drive mode or the part-load drive mode depending on a result of comparing a sum of the part-load torque and the motor torque with a driver demand torque.

12. The hybrid electric vehicle according to claim 11, wherein the first controller is configured to control the engine in the part-load drive mode when the sum is equal to or greater than the driver demand torque.

13. The hybrid electric vehicle according to claim 12, further comprising:
a second controller configured to control the engine; and
a third controller configured to control the motor,
wherein the first controller is configured to transmit a torque command corresponding to the part-load torque to the second controller, and transmit a torque command corresponding to a torque, obtained by subtracting the part-load torque from the driver demand torque, to the third controller.

14. The hybrid electric vehicle according to claim 11, wherein the first controller is configured to control the engine in the full-load drive mode when the sum is less than the driver demand torque.

15. The hybrid electric vehicle according to claim 14, further comprising:
a second controller configured to control the engine; and
a third controller configured to control the motor,
wherein the first controller is configured to transmit a torque command corresponding to a third maximum torque in the full-load drive mode to the second controller, and transmit a torque command corresponding to a torque, obtained by subtracting the third maximum torque in the full-load drive mode from the driver demand torque, to the third controller.

16. The hybrid electric vehicle according to claim 11, wherein the first controller is configured to determine the part-load torque based on an external environment condition and a current speed of the engine.

17. The hybrid electric vehicle according to claim 16, wherein the external environment condition comprises atmospheric pressure.

18. The hybrid electric vehicle according to claim 11, wherein the first controller determines the motor torque based on at least one of a current speed of the motor, a temperature of the motor, a state of charge of a battery, or a temperature of a power electric component.

19. A hybrid electric vehicle, comprising:
an engine;
a motor;
a transmission; and
a first controller configured to determine whether an extent of depression of an accelerator pedal (APS) is equal to or greater than a reference value set as a condition for entry of the engine into a full-load drive mode, to determine a part-load torque corresponding to a first maximum torque in a part-load drive mode of the engine and a motor torque corresponding to a second maximum torque of the motor when the extent of depression of the accelerator pedal is equal to or greater than the reference value, and to control the engine in the full-load drive mode or the part-load drive mode depending on a result of comparing a sum of the part-load torque and the motor torque with an allowable torque at an input end of the transmission.
